(19) United States
(12) Patent Application Publication
(10) Pub. No.: US 2006/0086252 A1
(43) Pub. Date: Apr. 27, 2006

(54) Air purifier

(76) Inventor: Hsi Cheng Huang, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/972,487

(22) Filed: Oct. 26, 2004

(51) Int. Cl. B01D 53/02

(52) U.S. Cl. 96/134

(57) ABSTRACT

Disposed is an air purifier, which includes a mounting structure with air inlets and air outlets for installation in the ceiling of a house, an air purifying unit formed of a photocatalytic filter and an active carbon-coated filter and a number of ultraviolet lamps and mounted inside the mounting unit, and a fan unit formed of a turbofan and mounted in the mounting structure for draw air into the air inlets toward the air outlets via the air purifying unit.

### BACKGROUND OF THE INVENTION

1. Field of the Invention

The present invention relates to an air purifier and more particularly, to such an air purifier that is practical for installation in the ceiling of a house to remove dust and bad smell from the air and to sterilize the air with ultraviolet light.

2. Description of the Related Art

In an enclosed indoor space of a house, office, plant, sales center, department store, or the like, an air-conditioning system may be used to regulate its humility and temperature. However, an air-conditioning system cannot purify the air. In order to purify the air, an air purifier shall be used. Conventional air purifiers are commonly designed for small area application. These air purifiers are not suitable for installation in the ceiling in a flash manner to purify the air of the whole indoor space.

### SUMMARY OF THE INVENTION

The present invention has been accomplished under the circumstances in view. It is one object of the present invention to provide an air purifier, which is practical for installation in the ceiling of a house to purify air. It is another object of the present invention to provide an air purifier, which removes dust and bad smell from air and sterilize filtered air. To achieve these and other objects of the present invention, the air purifier comprises a mounting structure for installation in a ceiling, the mounting structure having air inlets and air outlets, an air purifying unit mounted in the mounting structure, the air purifying unit comprising a grating, a photocatalytic filter, a carbon-coated air filter sandwiched in between the grating and the photocatalytic filter, and a plurality of ultraviolet lamps mounted in the bottom said of the grating; and a fan unit, which uses a turbofan to draw air from the air inlets toward the air outlets via the air purifying unit.

### BRIEF DESCRIPTION OF THE DRAWINGS

FIG. 1 is an exploded view of a fan unit for air purifier according to the present invention (the cover excluded).

FIG. 2 is an assembly of the fan unit shown in FIG. 1 after covering of a cover on the air accumulation chamber.

FIG. 3 is an exploded view of an air-purifying unit for air purifier according to the present invention.

FIG. 4 is an assembly view of FIG. 3.

FIG. 5 is an exploded view of a part of the present invention, showing the relationship between the mounting structure and the air-purifying unit.

FIG. 6 is an assembly view of FIG. 5.

FIG. 7 is an assembly view of the air purifier according to the present invention.

FIG. 8 is a schematic drawing showing the air purifier installed in the ceiling.

### DETAILED DESCRIPTION OF THE PREFERRED EMBODIMENT

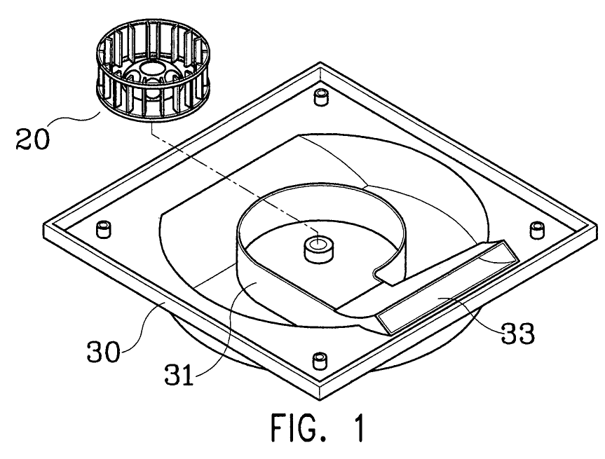

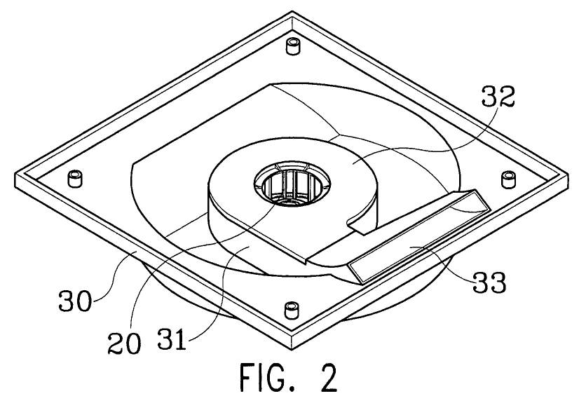

Referring to FIGS. 1 and 2, a casing 30 is shown defining therein an air accumulation chamber 31 covered with a cover 32, and an exhaust port 33 in air communication with the air accumulation chamber 31. A turbofan 20 is mounted inside the air accumulation chamber 31. The casing 30, the turbofan 20 and the cover 32 form a fan unit.

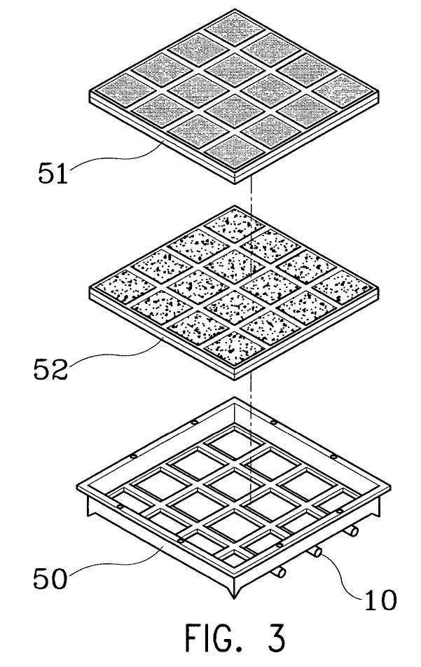

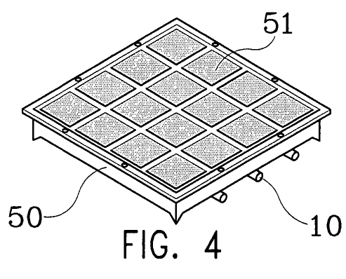

Referring to FIGS. 3 and 4, an air purifying unit is shown comprised of a grating 50, a plurality of ultraviolet lamps 10 provided at the bottom side of the grating 50, an active carbon-coated air filter 52 fastened to the top side of the grating 50, and a photocatalytic filter 51 covered on the top side of the carbon-coated air filter 52 opposite to the grating 50.

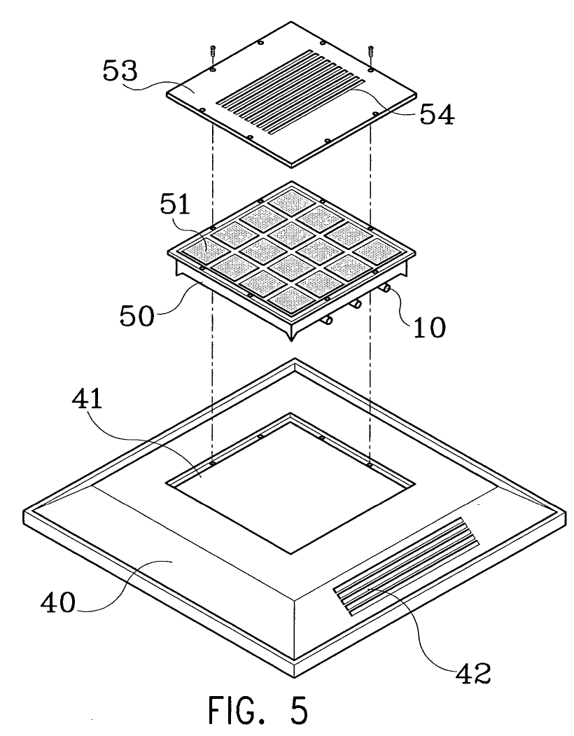

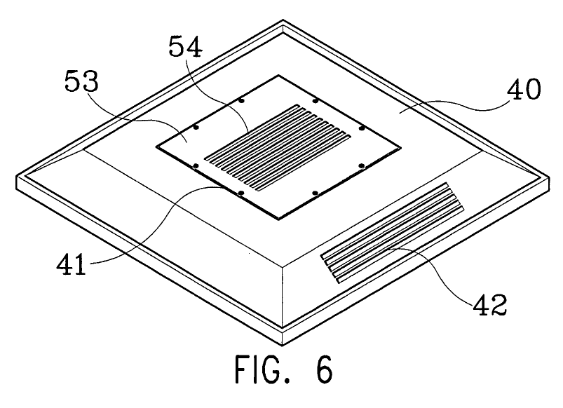

Referring to FIGS. 5 and 6 and FIGS. 3 and 4 again, the aforesaid air-purifying unit is mounted in the center mounting hole 41 of a flat mounting frame 40 and covered with cover board 53. The flat mounting frame 40 has a plurality of air outlets 42 maintained in air communication with the exhaust port 33. The cover board 53 is detachably fastened to the flat mounting frame 40 with screws to hold down the air-purifying unit in the center mounting hole 41, having a plurality of air inlets 54. The flat mounting frame 40 and the cover board 53 form a mounting structure for the air purifier according to the present invention.

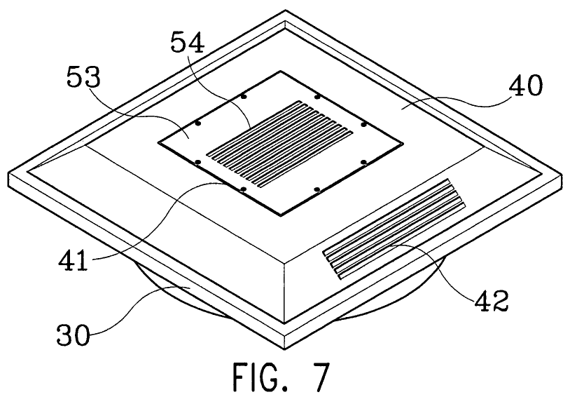

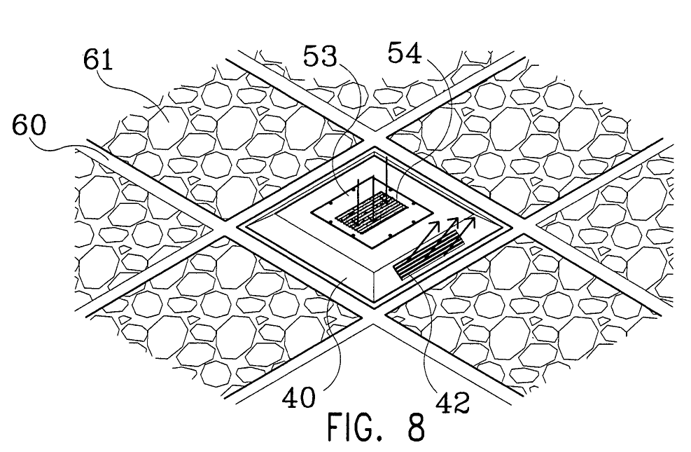

Referring to FIGS. 7 and 8 and FIGS. 1˜6 again, the casing 30 of the aforesaid fan unit is detachably fastened to the flat mounting frame 40 with screws and forming with the aforesaid air purifying unit, ultraviolet lamps 10 and turbofan 20 an air purifier. The air purifier is then installed in a ceiling formed of a lightduty steel framework 60 and ceiling panels 61. Preferably, the frame members of the air purifier are directly molded from plastics for the advantages of lightweight and low cost. After installation in the ceiling, the air purifier is electrically connected to a control circuit (not shown) for operation control. Alternatively, the electric circuit of the air purifier can be connected to the control circuit of a lighting fixture so that the air purifier is automatically started when the user turned on the lighting fixture. During operation of the air purifier, the turbofan 20 draw air from the house through the air inlets 54 toward the exhaust port 33 and the air outlets 42 via the photocatalytic filter 51 and carbon-coated air filter 52 of the air-purifying unit. When passing through the photocatalytic filter 51 and the carbon-coated air filter 52, solid matter and bad smell are removed from air, and ultraviolet light from the ultraviolet lamps 10 sterilizes the flow of air passing through the air purifying unit toward the air outlets 42, and therefore purified air is guided out of the air purifier through the air outlets 42 to the inside space of the house again.

A prototype of air purifier has been constructed with the features of FIGS. 1˜8. The air purifier functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An air purifier comprising:
a mounting structure for installation in a ceiling, said mounting structure comprising a mounting frame, said mounting frame having a center mounting hole and a plurality of air outlets, and a cover board fastened to said mounting frame and covered over said center mounting hole, said cover board having a plurality of air inlets;
an air purifying unit mounted in the center mounting hole of said mounting frame of said mounting structure and covered by said cover board, said air purifying unit comprising a grating mounted in the center mounting hole of said mounting frame of said mounting structure at a bottom side, a photocatalytic filter disposed in close contact with a bottom side of said cover board for the passing of air entering said air inlets, a carbon-coated air filter sandwiched in between said grating and said photocatalytic filter, and a plurality of ultraviolet lamps mounted in a bottom said of said grating; and
a fan unit, said fan unit comprising a casing fastened to said mounting frame of said mounting structure beneath said air purifying unit, said casing having an air accumulation chamber and an exhaust port in communication with the air outlets of the mounting frame of said mounting structure, and a turbofan mounted in said air accumulation chamber and adapted to draw air from said air inlets of said mounting structure through said air purifying unit toward said exhaust port of said casing and said air outlets of said mounting structure.
